(19) United States
(12) Patent Application Publication
(10) Pub. No.: US 2009/0280380 A1
(43) Pub. Date: Nov. 12, 2009

(54) PROTON CONDUCTING MEMBRANE FOR A FUEL CELL OR A REACTOR BASED ON FUEL CELL TECHNOLOGY

(75) Inventors: Olof Dahlberg, Vintrosa (SE); Alf Larsson, Karlskoga (SE)

Correspondence Address: PILLSBURY WINTHROP SHAW PITTMAN, LLP, P.O. BOX 10500, MCLEAN, VA, 22102, US

(73) Assignee: Morphic Technologies Aktiebolag (Publ.), Karlskoga (SE)

(21) Appl. No.: 12/304,385

(22) PCT Filed: Jun. 14, 2007
(86) PCT No.: PCT/SE2007/050420

§ 371 Date: Mar. 10, 2009

(30) Foreign Application Priority Data
Jun. 16, 2006 (SE) 0601351-0

(51) Int. Cl. H01M 8/10

(52) U.S. Cl. 429/33

(57) ABSTRACT

A proton conducting membrane for a fuel cell or a reactor based on fuel cell technology, consisting of a thin glass plate that allows for migration of protons from one side of the membrane to the other. Such a membrane is not affected by reactants that are common in DMFC cells, and is not permeable to ions other than protons/hydroxonium ions, and it does not conduct electrons. The glass may be ordinary soda lime glass and may be doped with silver chloride. Furthermore, a catalyst that is essential for conducting one of an anodic reaction and a cathodic reaction in the fuel cell or the reactor can be fused in the glass surface on one side of the membrane, and the catalyst that is essential for conducting the other reaction can be fused in the glass surface on the other side of the membrane.

### TECHNICAL FIELD

The present invention relates to a proton conducting membrane for a fuel cell or a reactor based on fuel cell technology.

By proton conducting membrane is in this context meant a membrane having the ability on its one side to receive protons/hydroxonium ions and on its other side to release a corresponding number of protons. When a proton enters the membrane from one side, another one is pushed out from the other side. The membrane will furthermore not allow for passage of electrons in the opposite direction and the passage of other ions than H⁺/H₃O⁺ is not desired.

By DMFC is in this context further understood a fuel cell driven by liquid methanol (Direct Methanol Fuel Cell), which fuel cell comprises an anodic side having an anode and a catalyst for the anodic reaction, a cathodic side having a cathode and a catalyst for the cathodic reaction, as well as an intermediate membrane that separates the anodic and cathodic sides from each other.

### PRIOR ART

Fuel cells driven by direct methanol are previously known, see for example Alexandre Hacquard, Improving and Understanding Direct Methanol Fuel Cell (DMFC) Performance, (Thesis submitted to the faculty of Worcester Polytechnic Institute) published on http://www.wpi.edu/Pubs/ETD/Available/etd-051205-151955/unrestricted/A.Hacquard.pdf. Among attainable advantages can be mentioned that the fuel is liquid, thus enabling fast fuelling, that both the fuel cell, that can be given a compact design, and the methanol, can be produced at low costs, and that the fuel cell can be designed for a number of different stationary or mobile/portable applications. Fuel cells of DMFC type are furthermore environmentally friendly, only water and carbon dioxide are discharged; no sulphur or nitrogen oxides are formed.

In the above mentioned publication, the anode and the cathode in the disclosed fuel cell consist of graphite and are both provided on their respective one side with a channel system or the like, at the anode for supply of a liquid methanol-water mixture and at the cathode for supply of oxygen, pure or air oxygen. Between the anode and the cathode there is a proton conducting membrane and between the membrane and the anode and the cathode, respectively, there is what is called a gas diffusion layer. Moreover, the gas diffusion layers or the membrane on the anodic side carries a catalyst of Pt and Ru and on the cathodic side a catalyst of solely Pt. The gas diffusion layers consist of carbon cloth or carbon paper. On the anodic side, the gas diffusion layer receives the CO₂ formed in connection with the oxidation of the methanol on the anodic catalyst and allows it to diffuse up to an upper end surface where CO₂ bubbles are formed. On the cathodic side, the supplied oxygen gas passes through the gas diffusion layer and reacts with electrons and protons passing through the membrane, to form water. Similar to membranes for other fuel cells driven by direct methanol, the membrane here consists of Nafion™, a sulphonated polymer of PTFE type. The catalysts are applied on the gas diffusion layers or on the membrane in the form of an ink of an organic solvent, finely powdered catalyst particles and a solution of Nafion™, after which the solvent is allowed to evaporate. It is stated to be essential to have a network of Nafion™ for efficient transport of protons to the membrane. The thus prepared gas diffusion layers are furthermore used as electrodes.

It has however been shown that Nafion™ does not have the desired methanol resistance but starts to dissolve already when exposed to 2 M (about 6%) methanol. Known fuel cells of DMFC type have moreover had too low a power density, due to the slow electrochemical oxidation of methanol at the anode, and that methanol has been able to migrate through the PEM membrane (Polymer Electrolyte Membrane) to the cathode where the methanol has oxidised. This results not only in fuel loss, but also in that the platinum catalyst used at the cathode is poisoned by formed carbon monoxide, which leads to decreased efficiency. The complexity of the reactions has made it difficult to achieve a satisfying yield.

### BRIEF ACCOUNT OF THE INVENTION

It is an object of the present invention to provide a proton conducting membrane that is not affected by the reactants in DMFC cells and that is not permeable to ions other than protons/hydroxonium ions.

In the membrane mentioned in the introduction, this object is achieved by the membrane consisting of a thin glass plate that allows for migration of protons from one membrane side to the other. In practice, glass is insoluble in water and a glass membrane is hence not affected by the reactants in a DMFC cell and is not permeable to ions other than protons/hydroxonium ions.

Preferably, the glass is ordinary soda lime glass. Such glass is cheap but fulfils the demands in terms of insolubility and corrosion resistance in the intended environment.

In order for the glass to be proton conducting, it is suitably doped with silver chloride. Other doping agents can be used but silver chloride is well known and relatively cheap.

It is suitable that a catalyst, that is essential in order to conduct an anodic reaction or a cathodic reaction in the fuel cell or the reactor, is fused in the glass surface on one side of the membrane. Preferably, a catalyst that is essential for conducting the anodic reaction, is fused in the glass surface on one side of the membrane and a catalyst that is essential for conducting the cathodic reaction is fused in the glass surface on the other side of the membrane. The catalyst is thereby protected against mechanical damage, at the same time as the possibility of a compact design is maintained, giving a high power density.

### BRIEF DESCRIPTION OF THE ENCLOSED DRAWINGS

In the following, the invention will be described in greater detail with reference to the preferred embodiments and the enclosed drawings.

FIG. 1 is a principle flowchart showing a fuel cell unit of DMFC type, in which liquid methanol is stepwise oxidised in fuel cells to form carbon dioxide and water.

FIG. 2 is a view in cross-section over the fuel cell unit according to FIG. 1, showing a preferred arrangement of electrodes, intermediate membranes and flow channels.

FIGS. 3-4 are planar views over a couple of different flow patterns in which the reactants can be lead inside each unit.

### DETAILED DESCRIPTION OF PREFERRED EMBODIMENTS

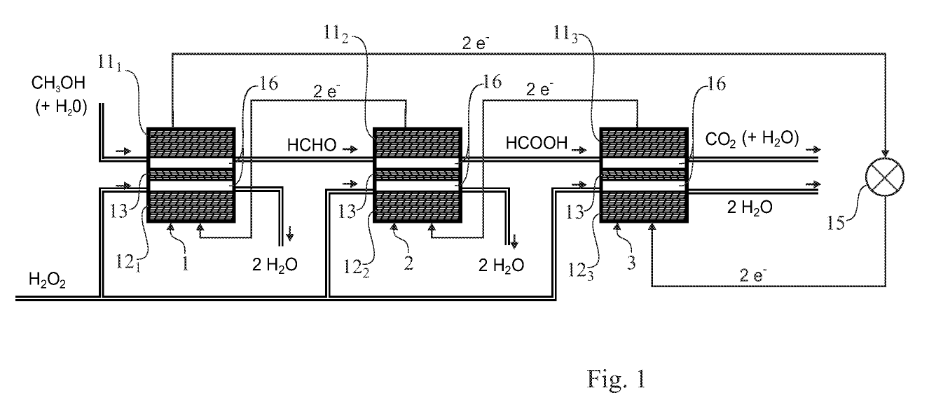

In the fuel cell unit of DMFC type shown in the principle flowchart in FIG. 1, liquid methanol is stepwise oxidised in fuel cells to carbon dioxide and water. The shown fuel cell unit comprises three fuel cells 1, 2 and 3 connected flow-wise in series, for conducting the stepwise oxidation in three separate steps. Each fuel cell comprises an anode 11, a cathode 12 and a membrane 13 that separates them from each other. On the anodic side, methanol is oxidised to formaldehyde in the first step 1, in the second step 2 the obtained formaldehyde is oxidised to formic acid and in the third step 3 the obtained formic acid is oxidised to carbon dioxide. On the cathodic side, freshly supplied hydrogen peroxide is reduced in each step 1-3, to form water. The supply of oxidant to the different steps is suitably controlled such that the reactions on the anodic and the cathodic sides are in stoichiometric balance with each other in every separate step. Thereby, the reactions can be more reliably refined and controlled in order to increase yield.

The three fuel cells 1, 2 and 3 are also electrically connected in series. Two electrons are going from the anode 11₁ in step one to the cathode 12₃ in step three, via a load 15, shown in the form of a bulb; two electrons are going from the anode 11₃ in step three to the cathode 12₂ in step two; and two electrons are going from the anode 11₂ in step two to the cathode 12₁ in step one. In all three cells 1, 2 and 3, formed protons/hydroxonium ions are going from the anode 11, through the membrane 13, to the cathode 12.

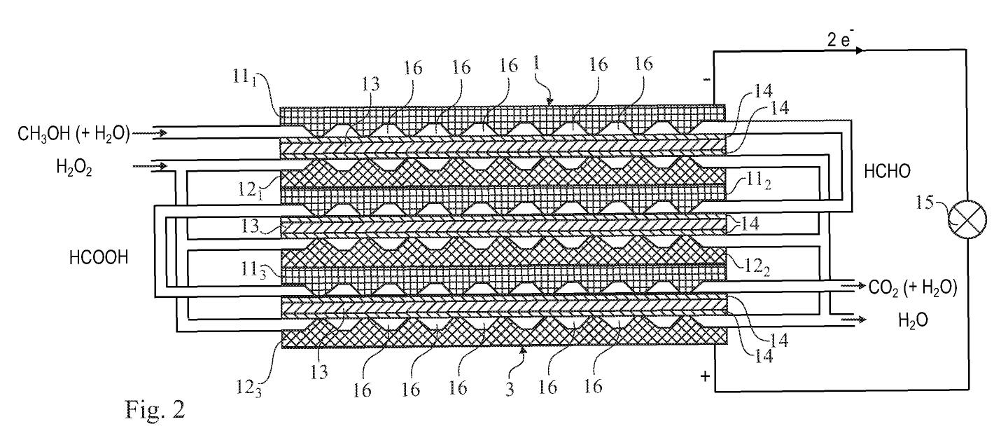

FIG. 2 is a view in cross-section over the fuel cell unit according to FIG. 1, showing a preferred arrangement of electrodes 11, 12, intermediate membranes 13 and flow channels 16. The anodes 11, the cathodes 12 and the membranes 13 are formed by thin plates or sheets that are attached to each other in order to form a package or a pile. The joining can be mechanical, e.g. by not shown connecting rods, but preferably not shown joints of a suitable glue, e.g. of silicone type, are used in order to hold the plates/sheets together. Between the membrane 13 and the anode 11 and between the membrane 13 and the cathode 12, a surface structure 16 is arranged that will give an optimised liquid flow over essentially the entire side of the plates. The flow lines shown in FIG. 1, between the separate fuel cells 1, 2 and 3, are constituted by flow connections that are formed in the plate package/pile but also by externally positioned flow connections shown in FIG. 2.

According to the invention, the membrane 13 consists of a thin glass plate that allows for migration of protons/hydroxonium ions from one side of the membrane 13 to the other. The glass may advantageously be constituted by cheap grades, such as soda lime glass and green glass. When such glass is made thin its resilience and its specific durability against load will increase. Several different metals are conceivable as doping agents in the glass, but preferably silver in the form of silver chloride is used, which is reasonably cheap. The doping agent as well as the small thickness of the glass facilitates the migration of protons/hydroxonium ions through the membrane. Moreover, the glass stops the passage of other ions and molecules, such as methanol, and it is not electrically conducting, which means that electrons from the cathode 12 cannot pass through the membrane 13 to the anode 11. Accordingly, no migration of methanol can take place from the anode 11 to the cathode 12, which means that there is no fuel loss due to migration of methanol and no formation of carbon monoxide at the cathode 12, which could otherwise decrease the efficiency of a platinum catalyst that is optionally used there.

In the preferred embodiment shown in FIG. 2, the anode 11, the cathode 12 and the membrane 13 have thicknesses of less than 1 mm. The anode 11 as well as the cathode 12 have one planar side and said surface structure 16, that gives an optimised liquid flow over essentially the entire side of the plate, is arranged on the anode 11 as well as on the cathode 12, while both sides of the intermediate membrane 13 are planar. The planar side of the cathode 12₁ in cell 1 in the fuel cell unit shown in FIG. 1 is then in abutting contact with the planar side of the anode 11₂ in cell 2, and so on. It is easily realised that a fuel cell 1, 2, 3 may have an anode 11, a membrane 13 as well as a cathode 12 that all have a planar side facing a side with surface structure 16 on an adjoining plate and vice versa, or an anode 11 and a cathode 12 with planar sides facing the membrane 13 whose both sides are provided with surface structure 16.

Suitably, the anode 11 as well as the cathode 12 are constituted of thin metal sheets of a material that is electrically conducting and resistant to the reactants, such as stainless steel, with a thickness in the magnitude of from 0.6 mm down to 0.1 mm, preferably 0.3 mm. Any surface structure in the membrane 13 as well as the surface structure in the anode 11 and the cathode 12 can be formed by channels 16 of waved cross-section. Suitably, the channels 16 have a width in the magnitude of 2 mm up to 3 mm and a depth in the magnitude of from 0.5 mm down to 0.05 mm. Any surface structure 16 in the membrane 13 is produced for example by etching and in the anode and the cathode plates 11, 12 it is produced by adiabatic forming, also called High Impact Forming. One example of such forming is disclosed in U.S. Pat. No. 6,821,471.

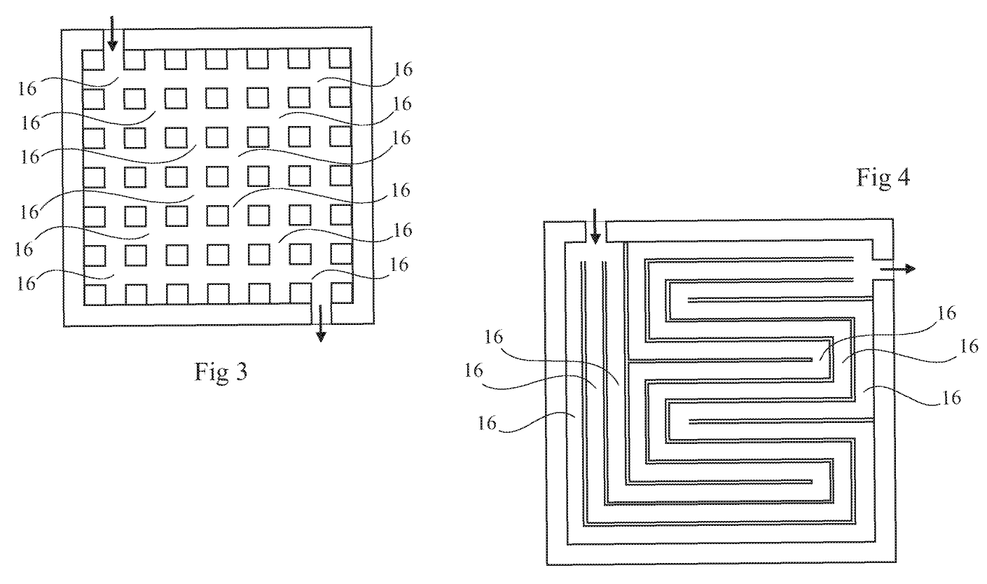

FIGS. 3 and 4 show a couple of different surface structures or flow patterns that will give an optimised liquid flow over essentially the entire side of the plate. In FIG. 3, parallel channels have been repeatedly perforated laterally, such that the entire surface structure consists of shoulders arranged in a checked pattern, forming a grating pattern of channels 16. Finally, FIG. 4 shows that meander shaped channels 16 that run in parallel also can be used. In all cases including different possible flow paths one should strive to make them equally long from inlet to outlet.

Preferably, the glass plate 13 has one planar side and the planar side is suitably provided with a catalyst that is essential for the conducting of an anodic reaction or a cathodic reaction in the fuel cell or the reactor, and preferably the catalyst is fused to the glass surface on one side of the membrane. It is thereby also suitable that the other side of the glass plate 13 is planar and that a catalyst, that is essential for the conducting of the cathodic reaction, is fused to the glass surface on the other side of the membrane. As is clear from FIG. 2, in which the two membranes 13 are moreover shown to be provided with a layer 14 of catalyst on both sides, the constructing of a compact pile of fuel cells 1, 2, 3 with electrodes 11, 12 of the same thin plate shape having one planar side and one side with surface structure is facilitated, whereby a high power density can be achieved.

By the catalyst suitably being fused to the surface of the glass, it is protected against mechanical damage at the same time as the compact construction that gives a high power density is maintained. The fusing is performed e.g. by laser, suitably in an inert atmosphere, and before the fusing the catalyst particles should naturally have been made really small, such by grinding in a ball mill, in order to increase the catalyst area.

Naturally, the catalysts are in all cases adapted to the reaction to be catalysed. Optimising the catalysts for the methanol driven fuel cell unit shown in FIG. 1 will e.g. result in that said first catalyst is formed by 60-94% Ag, 5-30% Te and/or Ru, and 1-10% Pt alone or in combination with Au and/or TiO₂, preferably at the ratio of about 90:9:1 for the reaction

CH₃OH [symbol] HCHO+2 H⁺+2 e⁻ (a)

of SiO₂ and TiO₂ in combination with Ag for the reaction

HCHO+H₂O [symbol] HCOOH+2 H⁺+2e⁻ (b)

of Ag alone or in combination with TiO₂ and/or Te for the reaction

HCOOH [symbol] CO₂+2 H⁺+2 e⁻ (c).

said second catalyst is then formed by e.g. carbon powder (carbon black), anthraquinone and Ag and phenolic resin, for the reaction

H₂O₂+2 H⁺+2 e⁻ [symbol] 2 H₂O (d).

As is mentioned above, the optimised catalyst for the second step is suitably constituted by SiO₂, TiO₂ and Ag. In case the membrane 13 consists of glass, SiO₂ is already comprised in the glass, which means that only TiO₂ and Ag need to be applied separately.

For the oxidation of methanol to acetaldehyde E⁰≈0.9 V, for the oxidation of acetaldehyde to formic acid E⁰≈0.4 V, and for the oxidation of formic acid to carbon dioxide E⁰≈0.2 V, and this together will give about 1.5-1.6 V at low load. When conversion is good, heat can be withdrawn from the middle cell 2.

Anthraquinone (CAS no. 84-65-1) is a crystalline powder that has a melting point of 286° C. and that is insoluble in water and alcohol but soluble in nitrobenzene and aniline. The catalyst can be produced by mixing carbon powder (carbon black), anthraquinone and silver with e.g. phenolic resin, after which it is formed into a coating that is allowed to dry. The coating is then released from its support, is crushed and finely grinded, after which the obtained powder is slurried in a suitable solvent, is applied where desired, after which the solvent is allowed to evaporate.

Naturally, catalysts can also be carried by one or both electrodes 11, 12. Alternatively, at least one of the catalysts, such as the one containing anthraquinone and silver, could be arranged in a not shown intermediate, separate carrier of e.g. carbon fibre felt. Such an arrangement will however mean that the diffusion will be slowed down, which means that this variant is less preferable although conceivable. The same catalysts can furthermore be used in a reactor of fuel cell type in order to drive the reactions backwards in order to produce methanol and hydrogen peroxide from carbon dioxide, water and electric energy.

1. A proton conducting membrane for a fuel cell or a reactor based on fuel cell technology, wherein the membrane comprises a thin glass plate that allows for migration of protons/hydroxonium ions from one side of the membrane to the other, and wherein a catalyst, that catalyzes conduction of an anodic reaction or a cathodic reaction in the fuel cell or the reactor, is fused in the glass surface on one side of the membrane.

2. A membrane according to claim 1 wherein the glass is ordinary soda lime glass.

3. A membrane according to claim 1, wherein the glass is doped with silver chloride.

4. A membrane according to claim 1, wherein a catalyst that catalyzes the anodic reaction is fused in the glass surface on one side of the membrane, and a catalyst that catalyzes the cathodic reaction is fused in the glass surface on the other side of the membrane.
